(19) United States
(12) Patent Application Publication
(10) Pub. No.: US 2018/0224278 A1
(43) Pub. Date: Aug. 9, 2018

(54) GYRO SENSOR, ELECTRONIC APPARATUS, AND VEHICLE

(71) Applicant: Seiko Epson Corporation, Tokyo (JP)

(72) Inventor: Makoto Furuhata, Matsumoto (JP)

(21) Appl. No.: 15/862,220

(22) Filed: Jan. 4, 2018

(30) Foreign Application Priority Data
Feb. 8, 2017 (JP) 2017-021210

(51) Int. Cl. G01C 19/06; G01C 19/5628; G01P 15/09; G01P 15/097

(52) U.S. Cl. CPC G01C 19/065; G01P 15/097; G01P 15/0922; G01C 19/5628

(57) ABSTRACT

A gyro sensor includes: a first signal generation unit that generates a first driving signal and a second driving signal with a different phase by 180 degrees from the first driving signal; a movable detection portion that vibrates in accordance with the first and second driving signals and is displaced in accordance with an angular velocity; a fixed detection portion that is disposed to face the movable detection portion; and a second signal generation unit that generates a signal with the same phase as the first or second driving signal and applies the signal to the fixed detection portion.

### BACKGROUND

### 1. Technical Field

The present invention relates to a gyro sensor, an electronic apparatus, and a vehicle.

### 2. Related Art

In recent years, gyro sensors measuring angular velocities have been developed using silicon micro electro mechanical system (MEMS) technologies. Gyro sensors have spread to uses of, for example, a camera shake correction function of a digital still camera (DSC), an automobile navigation system, a motion sensing function of a game apparatus, and the like.

In such gyro sensors, measurement vibration is excited with driving vibration in some cases (quadrature).

In gyro sensors, driving vibration of a vibrator is ideally vertical to a detection direction. The vibrator is not displaced in the detection direction as long as there is no input of an angular velocity. However, due to asymmetry or the like of a structure occurring in a manufacturing process (for example, when a cross-sectional shape which has to be originally square or rectangular is formed in a parallelogram or the like), a displacement component may occur in the detection direction when the vibrator is driven and vibrates (vibration leakage). This is referred to as quadrature.

In gyro sensors, when a driving frequency and a detection frequency of a vibrator slightly deviate from each other, vibration by quadrature of the vibrator obtains a gain due to a resonance phenomenon (resonance gain). Accordingly, an amplitude of the vibration by the quadrature of the vibrator increases, and thus the influence of the increase in the amplitude may not be neglected.

Here, the resonance phenomenon refers to a phenomenon in which when vibration is given to a vibrator from the outside, an amplitude of the vibration sharply increases as the given vibration is closer to a resonance frequency of the vibrator. A gain obtainable because of the resonance is referred to as a resonance gain. That is, vibration by the quadrature of the vibrator is resonated with driving vibration to be amplified.

For example, in a gyro sensor disclosed in JP-A-2007-304099, a plurality of orthogonal steering voltage members that electrostatically compensate a motion (vibration by quadrature) of a proof mass in an orthogonal direction are installed in order to suppress the motion of the proof mass in the orthogonal direction when the proof mass vibrates backwards and forwards on the upper side of a detection electrode.

In the gyro sensor disclosed in JP-A-2007-304099, a plurality of orthogonal steering voltage members have to be installed, and thus there is a problem that an element structure becomes complicated.

### SUMMARY

An advantage of some aspects of the invention is to provide a gyro sensor capable of reducing an influence of quadrature with a simple configuration. Another advantage of some aspects of the invention is to provide an electronic apparatus and a vehicle including the gyro sensor.

The invention can be implemented as the following forms or application examples.

### Application Example 1

A gyro sensor according to this application example includes: a first signal generation unit that generates a first driving signal and a second driving signal with a different phase by 180 degrees from the first driving signal; a movable detection portion that vibrates in accordance with the first and second driving signals and is displaced in accordance with an angular velocity; a fixed detection portion that is disposed to face the movable detection portion; and a second signal generation unit that generates a signal with the same phase as the first or second driving signal and applies the signal to the fixed detection portion.

In the gyro sensor, the second signal generation unit can reduce vibration by quadrature of the movable detection portion by the second signal generation unit applying the signal with the same phase as the first or second driving signal to the fixed detection portion. Further, in the gyro sensor, for example, it is possible to suppress the vibration by the quadrature without adding a member such as an electrode suppressing the vibration by the quadrature of the movable detection portion. Accordingly, in the gyro sensor, it is possible to reduce an influence of the quadrature with a simple configuration.

### Application Example 2

In the gyro sensor according to the application example, the second signal generation unit may include a selection unit that selects one of the first and second driving signals input from the first signal generation unit.

In the gyro sensor with this configuration, it is possible to generate a signal to reduce the vibration by the quadrature in accordance with a pattern of the vibration by the quadrature of the movable detection portion.

### Application Example 3

In the gyro sensor according to the application example, the second signal generation unit may include a voltage adjustment unit that adjusts a voltage of one of the first and second driving signals.

In the gyro sensor with this configuration, it is possible to generate a signal which is a signal with the same phase as the first or second driving signal and has an amplitude of a desired magnitude.

### Application Example 4

The gyro sensor according to the application example may further include a substrate; first and second fixed driving electrodes that are fixed to the substrate; a movable driving electrode that is disposed between the first and second fixed driving electrodes; and a vibrator to which the movable driving electrode is connected. The vibrator may vibrate when the first driving signal is applied to the first fixed driving electrode and the second driving signal is applied to the second fixed driving electrode. The movable detection portion may be connected to the vibrator.

In the gyro sensor with this configuration, it is possible to obtain an angular velocity from a signal based on a change in capacity between the movable detection portion and the fixed detection portion.

### Application Example 5

In the gyro sensor according to the application example, two movable detection portions may be installed. Two fixed detection portions may be installed. A first fixed detection portion which is one of the two fixed detection portions may be disposed to face a first movable detection portion which is one of the two movable detection portions. A second fixed detection portion which is the other of the two fixed detection portions may be disposed to face a second movable detection portion which is the other of the two movable detection portions. The first and second movable detection portions may vibrate in mutually opposite phases in accordance with the first and second driving signals.

In the gyro sensor with this configuration, since a detection signal from the first fixed detection portion and a detection signal from the second fixed detection portion can be differentially amplified, it is possible to detect a Coriolis signal with high precision.

### Application Example 6

In the gyro sensor according to the application example, two second signal generation units may be installed. One of the two second signal generation units may generate a signal with the same phase as the first or second driving signal and applies the signal to the first fixed detection portion. The other of the two second signal generation units may generate a signal with the same phase as the first or second driving signal and applies the signal to the second fixed detection portion.

In the gyro sensor with this configuration, even when the two movable detection portions are included, it is possible to reduce the influence of the quadrature with a simple configuration.

### Application Example 7

An electronic apparatus according to this application example includes the gyro sensor described above.

In the electronic apparatus, the gyro sensor that can reduce the influence of the quadrature with a simple configuration can be included.

### Application Example 8

A vehicle according to this application example includes the gyro sensor described above.

In the vehicle, the gyro sensor that can reduce the influence of the quadrature with a simple configuration can be included.

### BRIEF DESCRIPTION OF THE DRAWINGS

The invention will be described with reference to the accompanying drawings, wherein like numbers reference like elements.

FIG. 1 is a plan view schematically illustrating a sensor device.

FIG. 2 is a sectional view schematically illustrating the sensor device.

FIG. 3 is a sectional view schematically illustrating the sensor device.

FIG. 4 is a graph illustrating an example of vibration by quadrature of a detection flap plate.

FIG. 5 is a diagram illustrating an operation of the sensor device.

FIG. 6 is a diagram illustrating an operation of the sensor device.

FIG. 7 is a diagram illustrating a vibration form by the quadrature of the detection flap plate.

FIG. 8 is a diagram illustrating a vibration form by the quadrature of the detection flap plate.

FIG. 9 is a diagram illustrating a vibration form by the quadrature of the detection flap plate.

FIG. 10 is a graph illustrating a signal given to a fixed detection electrode.

FIG. 11 is a graph illustrating an example of vibration of the detection flap plate.

FIG. 12 is a diagram illustrating a vibration form of the detection flap plate.

FIG. 13 is a diagram illustrating a vibration form of the detection flap plate.

FIG. 14 is a functional block diagram illustrating the gyro sensor according to an embodiment.

FIG. 15 is a functional block diagram illustrating the gyro sensor according to a modification of the embodiment.

FIG. 16 is a functional block diagram illustrating an electronic apparatus according to the embodiment.

FIG. 17 is a diagram schematically illustrating an exterior example of a smartphone which is an example of the electronic apparatus.

FIG. 18 is a diagram schematically illustrating an external example of a portable apparatus which is an example of the electronic apparatus.

FIG. 19 is a top view schematically illustrating an example of a vehicle according to the embodiment.

### DESCRIPTION OF EXEMPLARY EMBODIMENTS

Hereinafter, preferred embodiments of the invention will be described in detail with reference to the drawings. The embodiments to be described below is not inappropriately limit content of the invention described in the appended claims. All of the configurations to be described below are not necessarily requisite factors of the invention.

### 1. First Embodiment

### 1.1. Sensor Device

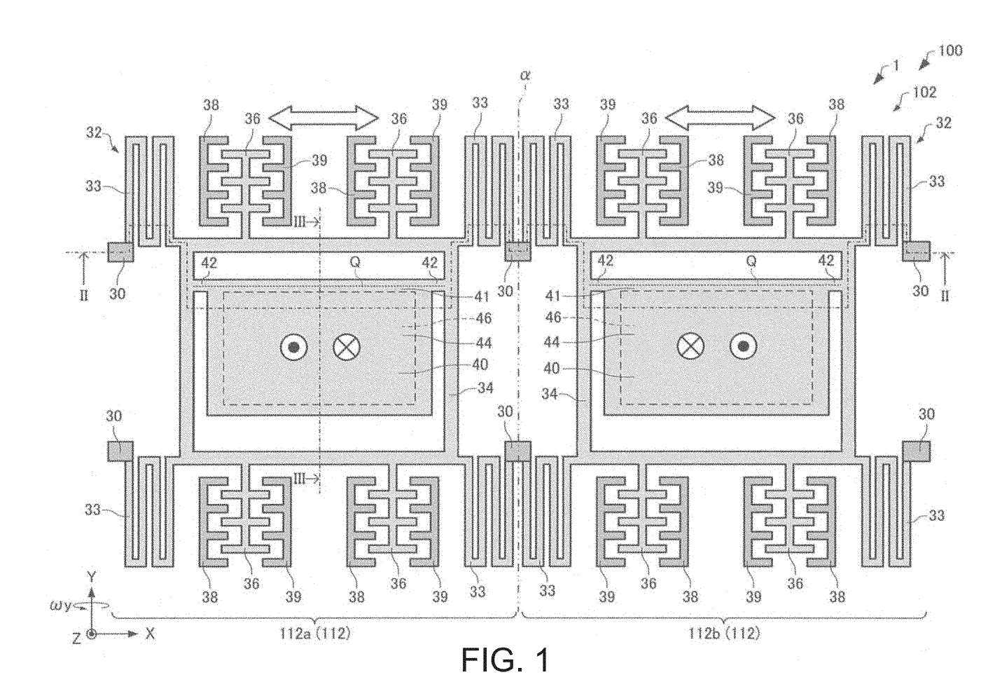

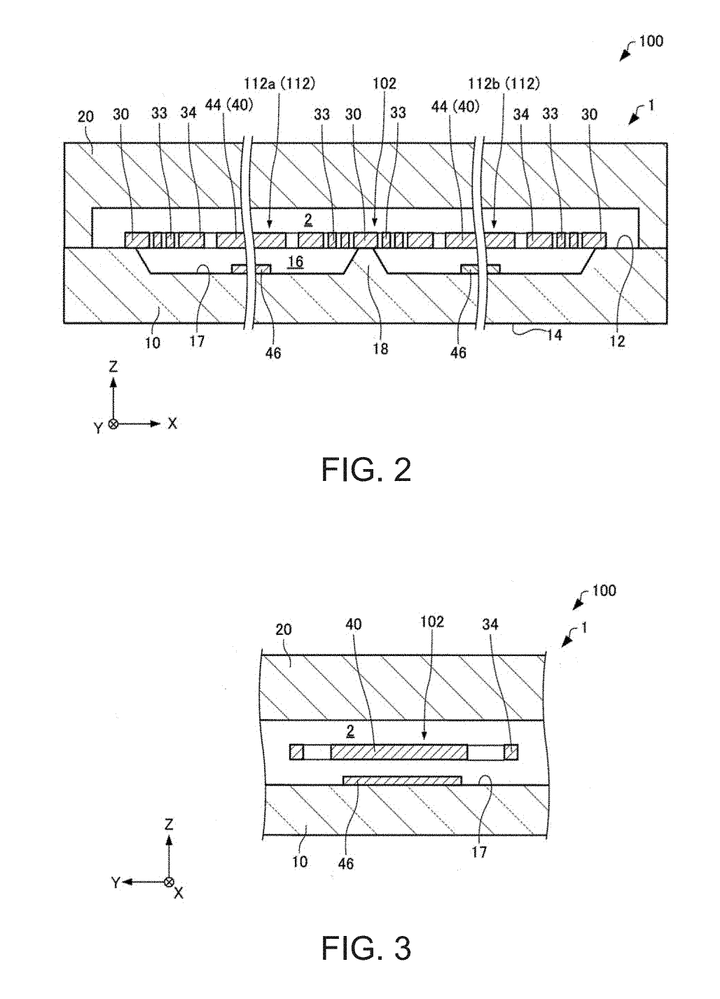

First, a sensor device 1 included in a gyro sensor 100 according to an embodiment will be described with reference to the drawings. FIG. 1 is a plan view schematically illustrating the sensor device 1 included in the gyro sensor 100 according to the embodiment. FIG. 2 is a sectional view taken along the line II-II of FIG. 1 schematically illustrating the sensor device 1 included in the gyro sensor 100 according to the embodiment. FIG. 3 is a sectional view taken along the line III-III of FIG. 1 schematically illustrating the sensor device 1 included in the gyro sensor 100 according to the embodiment. In FIGS. 1 to 3, three axes orthogonal to each other are illustrated as the X, Y, and Z axes.

As illustrated in FIGS. 1 to 3, the sensor device 1 includes a substrate 10, a lid 20, and a functional element 102. For convenience, the substrate 10 and the lid 20 are not illustrated in FIG. 1.

A material of the substrate 10 is, for example, glass or silicon. The substrate 10 includes a first surface 12 and a second surface 14 facing the first surface 12 in an opposite direction. A depression 16 is formed on the first surface 12. The depression 16 forms a cavity 2. A post portion 18 is formed on a bottom surface (a surface of the substrate 10 regulating the depression 16) 17 of the depression 16. The post portion 18 is a member that supports the functional element 102.

The lid 20 is installed on the substrate 10 (on a side in the +Z axis direction of the substrate 10). A material of the lid 20 is, for example, silicon. The lid 20 is bonded to the first surface 12 of the substrate 10. The substrate 10 and the lid 20 may be bonded by anodic bonding. In the illustrated example, a depression is formed in the lid 20. The depression forms the cavity 2.

A method of bonding the substrate 10 to the lid 20 is not particularly limited and may be, for example, bonding by low melting point glass (glass paste) or may be bonding by solder. The substrate 10 and the lid 20 may be bonded by forming metal thin films (not illustrated) in bonded portions of the substrate 10 and the lid 20 and performing eutectic bonding on the metal thin films.

The functional element 102 is installed on the side of the first surface 12 of the substrate 10. The functional element 102 is bonded to the substrate 10, for example, by anodic bonding or direct bonding. The functional element 102 is accommodated in the cavity 2 formed by the substrate 10 and the lid 20. The cavity 2 is preferably in a depression state. Thus, it is possible to suppress attenuation of vibration of the functional element 102 due to air viscosity.

The functional element 102 includes two structures 112 (a first structure 112a and a second structure 112b). As illustrated in FIG. 1, the two structures 112 are installed side by side in the X axis directional to be symmetric with respect to a virtual straight line a parallel to the Y axis.

The structure 112 includes fixed portions 30, driving spring portions 32, a vibrator 34, movable driving electrodes 36, fixed driving electrodes 38 (a first fixed driving electrode), fixed driving electrodes 39 (a second fixed driving electrode), a detection flap plate 40, beam portions 42, a movable detection electrode 44 (an example of a movable detection portion), and a fixed detection electrode 46 (an example of a fixed detection portion). The driving spring portions 32, the vibrator 34, the movable driving electrodes 36, the detection flap plate 40, the beam portions 42, and the movable detection electrode 44 are separate from the substrate 10.

The fixed portions 30 are fixed to the substrate 10. For example, the fixed portions 30 are bonded to the first surface 12 of the substrate 10 by anodic bonding. For example, four fixed portions 30 are installed for one structure 112. In the illustrated example, the structures 112a and 112b include the fixed portion 30 of the first structure 112a in the +X axis direction and the fixed portion 30 of the second structure 112b in the −X axis direction as common fixed portions. For example, the common fixed portions 30 are installed on the post portion 18.

The driving spring portion 32 connects the fixed portion 30 to the vibrator 34. The driving spring portion 32 is configured to include a plurality of beam portions 33. The plurality of beam portions 33 are installed to correspond to the number of fixed portions 30. The beam portions 33 extend in the X axis direction while reciprocating in the Y axis direction. The beam portions 33 (the driving spring portion 32) smoothly expand and contract in the X axis direction which is a vibration direction of the vibrator 34.

The vibrator 34 is, for example, a rectangular frame in a plan view. A side surface of the vibrator 34 in the X axis direction (for example, a side surface having a vertical line parallel to the X axis) is connected to the driving spring portion 32. The vibrator 34 can vibrate in the X axis direction by the movable driving electrodes 36 and the fixed driving electrodes 38 and 39. The movable driving electrodes 36, the driving spring portions 32 (the beam portions 33), and the beam portions 42 are connected to the vibrator 34.

The movable driving electrodes 36 are connected to the vibrator 34. In the illustrated example, four movable driving electrodes 36 are installed for one structure 112, two movable driving electrodes 36 are located on the side of the vibrator 34 in the +Y axis direction, and the other two movable driving electrodes 36 are located on the side of the vibrator 34 in the −Y axis direction. As illustrated in FIG. 1, the movable driving electrode 36 may have a pectinate shape that has a stem extending from the vibrator 34 in the Y axis direction and a plurality of branches extending from the stem in the X axis direction.

The fixed driving electrodes 38 and 39 are fixed to the substrate 10. For example, the fixed driving electrodes 38 and 39 are bonded to the first surface 12 of the substrate 10 by anodic bonding. The fixed driving electrodes 38 and 39 are installed to face the movable driving electrode 36. The movable driving electrode 36 is disposed between the fixed driving electrodes 38 and 39. As illustrated in FIG. 1, when the movable driving electrode 36 has the pectinate shape, the fixed driving electrodes 38 and 39 may have a pectinate shape corresponding to the movable driving electrode 36. The movable driving electrode 36 and the fixed driving electrodes 38 and 39 are electrodes that vibrate the vibrator 34.

The detection flap plate 40 is connected to (supported by) the vibrator 34 via the beam portions 42. The side surface of the detection flap plate 40 in the X axis detection (for example, a side surface that has a vertical line parallel to the X axis) is connected to the beam portions 42. The detection flap plate 40 is installed inside the frame-shaped vibrator 34 in the plan view. The detection flap plate 40 has a plate shape. In the illustrated example, the shape of the detection flap plate 40 is rectangular in the plan view.

The beam portions 42 connect the vibrator 34 to the detection flap plate 40. In the illustrated example, two beam portions 42 are installed in one structure 112. In one structure 112, the two beam portions 42 and a portion of the detection flap plate 40 interposed between the two beam portions 42 configure a rotational pivot portion 41. The rotational pivot portion 41 has a rotational axis Q and can perform torsional deformation. The torsional deformation enables the detection flap plate 40 to be displaced in the Z axis direction. That is, the detection flap plate 40 has the rotational axis Q (has a part of the rotational axis Q) and can be displaced in the Z axis direction (the thickness direction of the substrate 10). In the illustrated example, the rotational axis Q is parallel to the X axis.

The movable detection electrode 44 is installed in the detection flap plate 40. The movable detection electrode 44 is a portion that overlaps the fixed detection electrode 46 in the plan view in the detection flap plate 40. The movable detection electrode 44 forms electrostatic capacitance with the fixed detection electrode 46.

The fixed portions 30, the driving spring portions 32, the vibrator 34, the movable driving electrodes 36, the detection flap plate 40, the beam portions 42, and the movable detection electrode 44 are installed to be integrated. A material of the fixed portions 30, the driving spring portions 32, the vibrator 34, the movable driving electrodes 36, the fixed driving electrodes 38 and 39, the detection flap plate 40, the beam portions 42, and the movable detection electrode 44 is, for example, silicon that has conductivity by doping impurities such as phosphorus or boron.

The fixed detection electrode 46 is fixed to the substrate 10. The fixed detection electrode 46 is installed on the substrate 10 (the bottom surface 17 of the depression 16). In the illustrated example, the shape of the fixed detection electrode 46 is rectangular in the plan view. The fixed detection electrode 46 is disposed to face the detection flap plate 40. The fixed detection electrode 46 is disposed to form electrostatic capacitance with the detection flap plate 40.

A material of the fixed detection electrode 46 is, for example, aluminum, gold, or indium tin oxide (ITO). By using a transparent electrode material such as ITO as the fixed detection electrode 46, foreign substances or the like on the fixed detection electrode 46 can be easily viewed from the second surface 14 of the substrate 10.

### 1.2. Operation of Sensor Device

Next, an operation of the sensor device 1 will be described.

When a power supply (not illustrated) applies a voltage between the movable driving electrodes 36 and the fixed driving electrodes 38 and 39, an electrostatic force can be generated between the movable driving electrodes 36 and the fixed driving electrodes 38 and 39. Thus, the vibrator 34 can vibrate in the X axis direction. At this time, the driving spring portions 32 expand and contract in the X axis direction.

Specifically, a constant bias voltage Vdc is given to the movable driving electrodes 36. Further, a first driving signal V1 is applied to the fixed driving electrodes 38 via driving wirings (not illustrated). A second driving signal V2 is applied to the fixed driving electrodes 39 via driving wirings (not illustrated). The first driving signal V1 and the second driving signal V2 are alternating-current voltages with the same frequency and a phase of the second driving signal V2 is different from that of the first driving signal V1 by 180 degrees. The first driving signal V1 and the second driving signal V2 are alternating-current voltages of which amplitudes are the same, for example, using the same potential as a reference.

As illustrated in FIG. 1, in the first structure 112a, the fixed driving electrodes 38 are disposed on the sides of the movable driving electrodes 36 in the −X axis direction and the fixed driving electrodes 39 are disposed on the sides of the movable driving electrodes 36 in the +X axis direction. In the second structure 112b, the fixed driving electrodes 38 are disposed on the sides of the movable driving electrodes 36 in the +X axis direction and the fixed driving electrodes 39 are disposed on the sides of the movable driving electrodes 36 in the −X axis direction. Therefore, the first driving signal V1 and the second driving signal V2 enable the vibrator 34 of the first structure 112a and the vibrator 34 of the second structure 112b to vibrate at mutually opposite phases (that is, the phases are deviated by 180 degrees) at a predetermined frequency in the X axis.

In this way, the vibrators 34 vibrate in the X axis direction in accordance with the first driving signal V1 and the second driving signal V2. Therefore, the movable detection electrodes 44 connected to the vibrators 34 also vibrate in the X axis direction in accordance with the first driving signal V1 and the second driving signal V2 as in the vibrators 34. Specifically, the movable detection electrode 44 (an example of a first movable detection portion) of the first structure 112a and the movable detection electrode 44 (an example of a second movable detection portion) of the second structure 112b vibrate at mutually opposite phases in accordance with the first driving signal V1 and the second driving signal V2.

When an angular velocity ωy around the Y axis is applied to the sensor device 1 in a state in which the vibrators 34 vibrate (are driven and vibrate), a Coriolis force works. Thus, the detection flap plate 40 of the first structure 112a and the detection flap plate 40 of the second structure 112b are displaced in mutually opposite directions in the Z axis direction (along the Z axis). The detection flap plates 40 repeat this operation (measurement vibration) while the Coriolis force is received.

When the detection flap plate 40 is displaced in the Z axis direction, a distance between the movable detection electrode 44 and the fixed detection electrode 46 is changed. Therefore, the electrostatic capacitance between the movable detection electrode 44 and the fixed detection electrode 46 is changed. By measuring a change amount of the electrostatic capacitance between the movable detection electrode 44 and the fixed detection electrode 46, it is possible to obtain the angular velocity ωy around the Y axis.

In the sensor device 1, by applying a voltage between the movable detection electrode 44 and the fixed detection electrode 46, a change amount of the electrostatic capacitance between the movable detection electrode 44 and the fixed detection electrode 46 can be measured.

Specifically, the constant bias voltage Vdc is given to the movable detection electrode 44. A ground voltage (reference voltage) Vgnd or a constant potential is given to the fixed detection electrode 46. Thus, it is possible to detect a change amount of the electrostatic capacitance between the movable detection electrode 44 and the fixed detection electrode 46.

A compensation signal Vcomp is given to the fixed detection electrode 46 in addition to the ground voltage Vgnd.

The compensation signal Vcomp which is given to the fixed detection electrode 46 is an alternating-current voltage with the same frequency as the first driving signal V1 and the second driving signal V2. As will be described below, there are a case in which the compensation signal Vcomp is an alternating voltage with the same phase as the first driving signal V1 and a case in which the compensation signal Vcomp is an alternating voltage with the same phase as the second driving signal V2 in accordance with two vibration patterns by the quadrature of the detection flap plate 40. By giving the compensation signal Vcomp to the fixed detection electrode 46, it is possible to reduce the influence of the quadrature. Hereinafter, the compensation signal Vcomp will be described.

First, an operation of the detection flap plate 40 of the first structure 112a when the compensation signal Vcomp is not given to the fixed detection electrode 46 will be described. Hereinafter, it is assumed that no angular velocity is added to the sensor device 1.

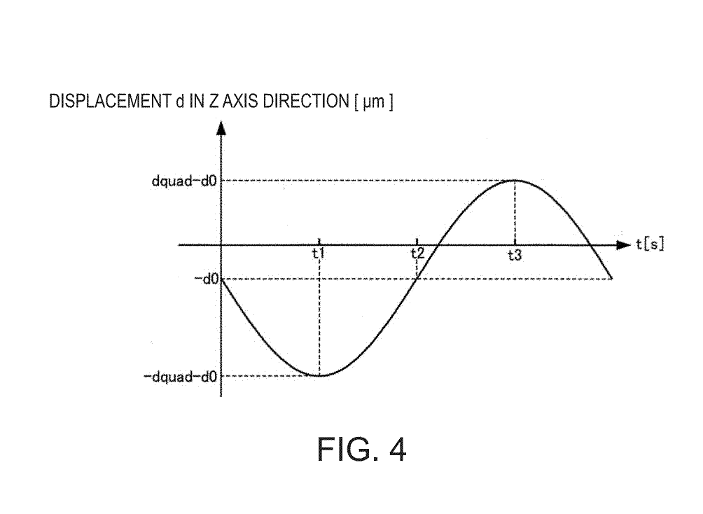

FIG. 4 is a graph illustrating an example of vibration (a displacement d of a free end of the detection flap plate 40 in the Z axis direction) by the quadrature of the detection flap plate 40 of the first structure 112a when the compensation signal Vcomp is not given to the fixed detection electrode 46.

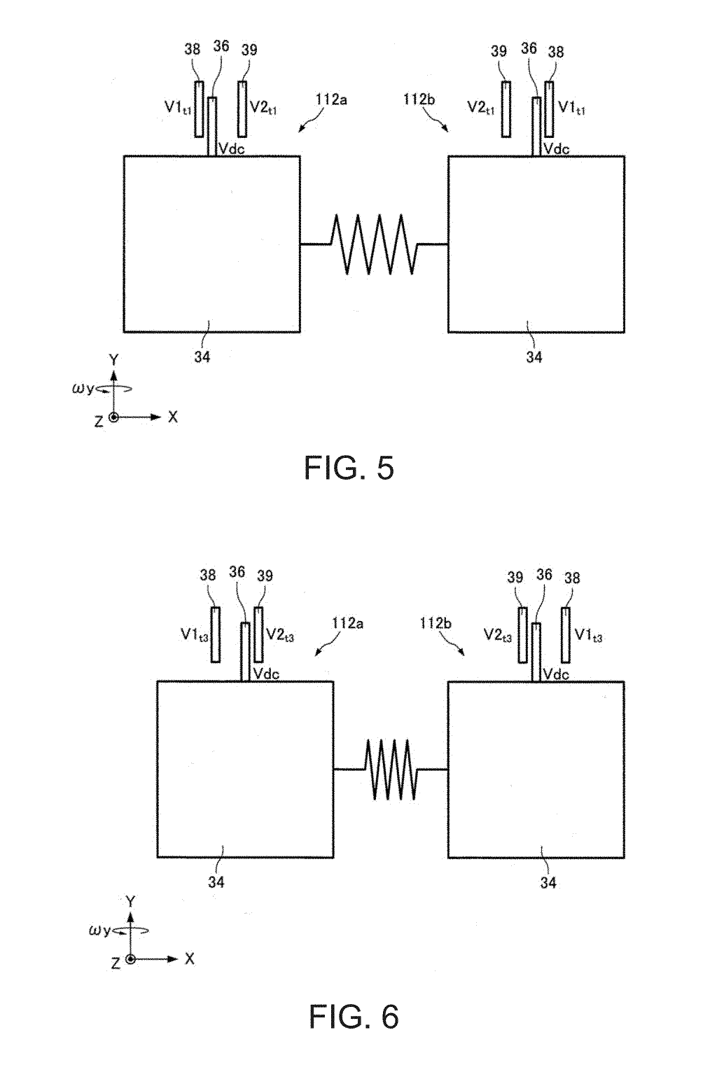

FIGS. 5 and 6 are diagrams illustrating an operation of the sensor device 1. FIG. 5 illustrates a form of the operation of the sensor device 1 at time t1 and FIG. 6 illustrates a form of the operation of the sensor device 1 at time t3.

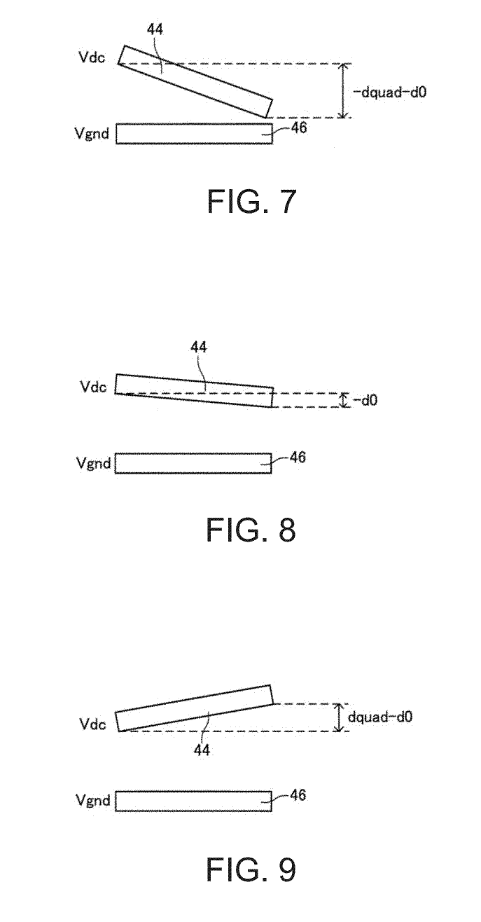

FIGS. 7 to 9 are diagrams illustrating vibration forms by the quadrature of the detection flap plate 40 when the compensation signal Vcomp is not given to the fixed detection electrode 46. FIG. 7 illustrates a state of the detection flap plate 40 at time t1, FIG. 8 illustrates a state of the detection flap plate 40 at time t2, and FIG. 9 illustrates a state of the detection flap plate 40 at time t3.

At time t1, the first driving signal V1=V1ₜ₁ is applied to the fixed driving electrode 38 and the second driving signal V2=V2ₜ₁ is applied to the fixed driving electrode 39 (where V1ₜ₁<V2ₜ₁). Thus, as illustrated in FIG. 5, the vibrator 34 of the first structure 112a moves in the −X axis direction and the vibrator 34 of the second structure 112b moves in the +X axis direction. At this time, the detection flap plate 40 of the first structure 112a is displaced by −dquad−d0 in the Z axis direction by the quadrature, as illustrated in FIG. 7.

A displacement d=dquad is magnitude of a displacement (amplitude) of the detection flap plate 40 in the Z axis direction by the quadrature. A displacement d=d0 is magnitude of a displacement in the Z axis direction in an initial state (a state in which vibration by the quadrature is not excited) of the detection flap plate 40. That is, the displacement d=d0 is magnitude of a displacement of the detection flap plate 40 in the Z axis direction at time t2 illustrated in FIG. 8.

At time t3, the first driving signal V1=V1ₜ₃ is applied to the fixed driving electrode 38 and the second driving signal V2=V2ₜ₃ is applied to the fixed driving electrode 39 (where V1ₜ₃>V2ₜ₃). Thus, as illustrated in FIG. 6, the vibrator 34 of the first structure 112a moves in the +X axis direction and the vibrator 34 of the second structure 112b moves in the −X axis direction. At this time, the detection flap plate 40 of the first structure 112a is displaced by dquad-d0 in the Z axis direction by the quadrature, as illustrated in FIG. 9.

Next, an operation of the detection flap plate 40 of the first structure 112a when the compensation signal Vcomp is given to the fixed detection electrode 46 will be described.

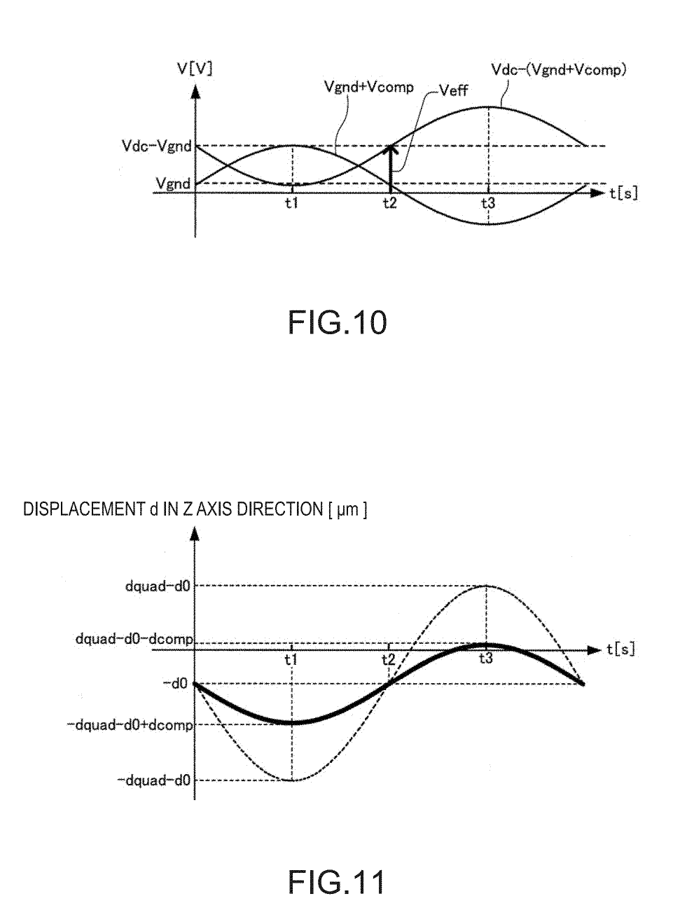

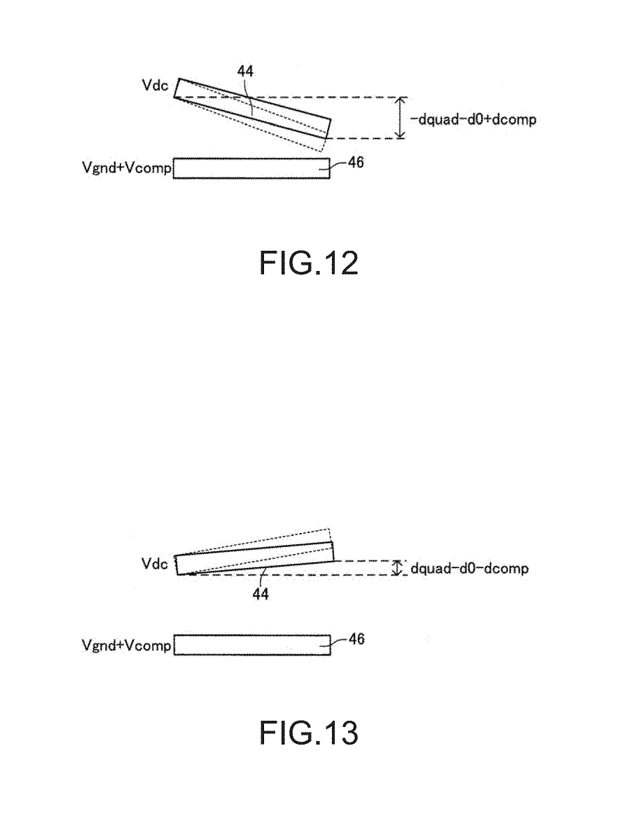

FIG. 10 is a graph illustrating a voltage Vgnd+Vcomp given to the fixed detection electrode 46 of the first structure 112a and a voltage Vdc−(Vgnd+Vcomp) given between the movable detection electrode 44 and the fixed detection electrode 46. FIG. 11 is a graph illustrating an example of vibration of the detection flap plate 40 of the first structure 112a when the compensation signal Vcomp is given to the fixed detection electrode 46 of the first structure 112a. FIGS. 12 and 13 are diagrams illustrating forms of vibration of the detection flap plate 40 when the compensation signal Vcomp is given to the fixed detection electrode 46. FIG. 12 illustrates a state of the detection flap plate 40 at time t1 and FIG. 13 illustrates a state of the detection flap plate 40 at time t3.

In the example illustrated in FIG. 10, the compensation signal Vcomp is an alternating-current voltage with the same phase as the second driving signal V2. When the compensation signal Vcomp is given to the fixed detection electrode 46, the voltage Vdc−(Vgnd+Vcomp) is given between the movable detection electrode 44 and the fixed detection electrode 46.

At time t1, as illustrated in FIG. 5, the vibrator 34 of the first structure 112a moves in the −X axis direction and the vibrator 34 of the second structure 112b moves in the +X axis direction. At this time, the detection flap plate 40 of the first structure 112a is displaced by −dquad−d0+dcomp in the Z axis direction, as illustrated in FIG. 12. That is, a displacement (amplitude) in the Z axis direction by the quadrature of the detection flap plate 40 is suppressed by +dcomp (where dcomp>0). This is because at time t1, the voltage Vdc−(Vgnd+Vcomp) given between the movable detection electrode 44 and the fixed detection electrode 46 is less than the voltage Vdc−Vgnd when the compensation signal Vcomp is not given. That is, this is because, at time t1, when the compensation signal Vcomp is given to the fixed detection electrode 46, an electrostatic force (electrostatic attraction) acting between the movable detection electrode 44 and the fixed detection electrode 46 is less than when the compensation signal Vcomp is not given.

At time t3, as illustrated in FIG. 6, the vibrator 34 of the first structure 112a moves in the +X axis direction and the vibrator 34 of the second structure 112b moves in the −X axis direction. At this time, the detection flap plate 40 of the first structure 112a is displaced by dquad−d0−dcomp in the Z axis direction, as illustrated in FIG. 13. That is, a displacement in the Z axis direction by the quadrature of the detection flap plate 40 is suppressed by −dcomp. This is because at time t3, the voltage Vdc−(Vgnd+Vcomp) given between the movable detection electrode 44 and the fixed detection electrode 46 is greater than the voltage Vdc−Vgnd when the compensation signal Vcomp is not given. That is, this is because, at time t3, when the compensation signal Vcomp is given to the fixed detection electrode 46, an electrostatic force (electrostatic attraction) acting between the movable detection electrode 44 and the fixed detection electrode 46 is greater when the compensation signal Vcomp is not given.

Accordingly, by giving the compensation signal Vcomp with the same phase as the second driving signal V2 to the fixed detection electrode 46, as illustrated in FIG. 11, it is possible to suppress vibration by the quadrature of the detection flap plate 40. In this way, by giving the compensation signal Vcomp (see FIG. 10) with the same phase as a driving signal with an opposite phase to the vibration (see FIG. 4) by the quadrature of the detection flap plate 40 to the fixed detection electrode 46, it is possible to suppress the vibration by the quadrature of the detection flap plate 40.

In the sensor device 1, a resonance frequency (detection frequency) of the detection flap plate 40 slightly deviates from a resonance frequency (driving frequency) of the vibrator 34. Therefore, when the compensation signal Vcomp with the same frequency (that is, the same frequency as the driving frequency) as that of the second driving signal V2 is given to the fixed detection electrode 46, the electrostatic force by the resonance phenomenon is a multiple of the resonance gain. Accordingly, it is possible to suppress the vibration by the quadrature of the detection flap plate 40 by the small compensation signal Vcomp.

The resonance phenomenon refers to a phenomenon in which when vibration is given to the detection flap plate 40 from the outside, an amplitude of the vibration of the detection flap plate 40 sharply increases as the given vibration is closer to a resonance frequency of the detection flap plate 40. A gain obtainable because of the resonance is referred to as a resonance gain. In the embodiment, by using the resonance phenomenon, it is possible to cause the magnitude (voltage amplitude) of the compensation signal Vcomp to be less than when the resonance phenomenon is not used.

A detection signal (alternating current) output from the fixed detection electrode 46 includes a Coriolis signal which is an angular velocity component based on a Coriolis force working on the sensor device 1 and a quadrature signal (leakage signal) based on a self-vibration component (quadrature) based on the driving vibration of the sensor device 1. A phase deviates by 90 degrees between the quadrature signal and the Coriolis signal included in the detection signal output from the fixed detection electrode 46. Therefore, when the Coriolis signal is detected, a state in which Veff=Vdc−Vgnd (see FIG. 10) is given between the movable detection electrode and the fixed detection electrode 46 is achieved. Accordingly, even when the compensation signal Vcomp is given to the fixed detection electrode 46, an influence on detection of an angular velocity is small. For example, it is also easy to eliminate a signal by the compensation signal Vcomp from the detection signal output from the fixed detection electrode 46.

As described above, the detection flap plate 40 is displaced in the −Z axis direction when the vibrator 34 of the first structure 112a moves in the −X axis direction, and the detection flap plate 40 is displaced in the +Z axis direction when the vibrator 34 moves in the +X axis direction (a first vibration pattern). The detection flap plate 40 moves oppositely by the quadrature. That is, the detection flap plate 40 is displaced in the +Z axis direction when the vibrator 34 of the first structure 112a moves in the −X axis direction, and the detection flap plate 40 is displaced in the −Z axis direction when the vibrator 34 moves in the +X axis direction (a second vibration pattern). This is because asymmetry of the structure of the sensor device 1 in a manufacturing process is not uniform and the asymmetry of the structure differs for each element.

When the detection flap plate 40 of the first structure 112a vibrates by the quadrature in the second vibration pattern, the compensation signal Vcomp given to the fixed detection electrode 46 of the first structure 112a is an alternating-current voltage with the same phase as the first driving signal V1.

The compensation signal Vcomp given to the fixed detection electrode 46 of the first structure 112a has been described above, but the compensation signal Vcomp is similarly given to the fixed detection electrode 46 of the second structure 112b. Thus, it is possible to suppress the vibration by the quadrature of the detection flap plate 40 of the second structure 112b.

For example, when the detection flap plate 40 is displaced in the −Z axis direction in a case in which the vibrator 34 of the second structure 112b moves in the +X axis direction and the detection flap plate 40 is displaced in the +Z axis direction in a case in which the vibrator 34 of the second structure 112b moves in the −X axis direction, the compensation signal Vcomp given to the fixed detection electrode 46 of the second structure 112b is an alternating-current voltage with the same phase as the second driving signal V2.

When the detection flap plate 40 is displaced in the +Z axis direction in a case in which the vibrator 34 of the second structure 112b moves in the +X axis direction and the detection flap plate 40 is displaced in the −Z axis direction in a case in which the vibrator 34 of the second structure 112b moves in the −X axis direction, the compensation signal Vcomp given to the fixed detection electrode 46 of the second structure 112b is an alternating-current voltage with the same phase as the first driving signal V1.

### 1.3. Method of Manufacturing Sensor Device

Next, a method of manufacturing the sensor device 1 will be described.

First, a glass substrate is prepared and the glass substrate is patterned to form the depressions 16 and the post portions 18 and form the substrate 10.

Subsequently, the fixed detection electrodes 46 are formed on the bottom surfaces 17 of the depressions 16. Subsequently, after a silicon substrate is bonded to the first surface 12 of the substrate 10 by anodic bonding and the silicon substrate is ground to be thinned, patterning is performed in a predetermined shape to form the functional element 102. Through the foregoing processes, it is possible to form the functional elements 102 that include the fixed portions 30, the driving spring portions 32, the vibrators 34, the movable driving electrodes 36, the fixed driving electrodes 38 and 39, the detection flap plates 40, the beam portions 42, the movable detection electrodes 44, and the fixed detection electrodes 46.

Subsequently, the substrate 10 is bonded to the lid 20 (for example, by anodic bonding) and the functional element 102 is accommodated in the cavity 2 formed by the substrate 10 and the lid 20.

Through the foregoing processes, it is possible to manufacture the sensor device 1.

### 1.4. Configuration of Gyro Sensor

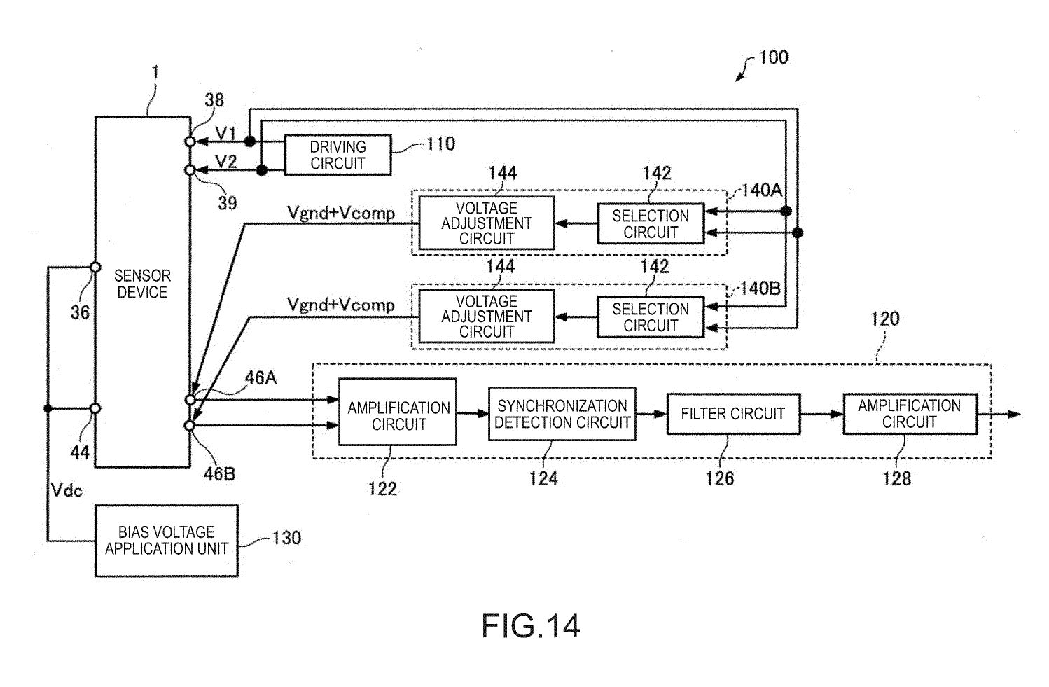

Next, a configuration of the gyro sensor 100 will be described with reference to the drawings. FIG. 14 is a functional block illustrating the gyro sensor 100.

The gyro sensor 100 is configured to include the foregoing sensor device 1, a driving circuit 110 (an example of a first signal generation unit), a detection circuit 120, a bias voltage application unit 130, and compensation signal generation circuits 140A and 140B (an example of a second signal generation unit).

The driving circuit 110 generates the first driving signal V1 and the second driving signal V2, outputs the first driving signal V1 to the fixed driving electrodes 38, and outputs the second driving signal V2 to the fixed driving electrodes 39. For example, the driving circuit 110 may generate the driving signals V1 and V2 based on a signal from a monitor electrode (not illustrated) detecting a vibration state of the vibrator 34 and output the driving signals V1 and V2 to the fixed driving electrodes 38 and 39. The driving circuit 110 outputs the driving signals V1 and V2 to drive the sensor device 1 and receive a feedback signal from the sensor device 1 to excite the sensor device 1.

The detection circuit 120 is configured to include an amplification circuit 122, a synchronization detection circuit 124, a filter circuit 126, and an amplification circuit 128.

A detection signal output from the fixed detection electrode 46 (also referred to as a “fixed detection electrode 46A”) of the first structure 112a and a detection signal output from the fixed detection electrode 46 (also referred to as a “fixed detection electrode 46B”) of the second structure 112b include a Coriolis signal and a quadrature signal. The detection circuit 120 extracts the Coriolis signals from the signals output from the fixed detection electrode 46A and 46B.

When the vibrator 34 of the sensor device 1 vibrates, a current based on a change in capacitance is output from the fixed detection electrodes 46A and 46B and is input to the amplification circuit 122. The amplification circuit 122 converts the current based on the change in the capacitance output from the fixed detection electrodes 46A and 46B into voltage and amplifies the voltage, and outputs the amplified voltage as an alternating-current voltage signal to the synchronization detection circuit 124. The amplification circuit 122 is configured to include, for example, a Q/V converter (a charge amplifier).

For example, the synchronization detection circuit 124 detects synchronization of the signal from the fixed detection electrodes 46A and 46B based on a signal from the above-described monitor electrode (not illustrated) and extracts the Coriolis signal. The Coriolis signal extracted by the synchronization detection circuit 124 is input to the filter circuit 126.

The filter circuit 126 is configured to include a lowpass filter that removes a high-frequency component from the Coriolis signal and converts the Coriolis signal into a direct-current voltage signal. The filter circuit 126 outputs an output signal to the amplification circuit 128.

The amplification circuit 128 amplifies an input signal and outputs the voltage signal based on an angular velocity.

The bias voltage application unit 130 applies the bias voltage Vdc to the vibrator 34. The bias voltage application unit 130 applies the bias voltage Vdc to the vibrator 34 via the fixed portions 30. Since the vibrator 34 has an integrated structure of the movable driving electrode 36 and the movable detection electrode 44 (the detection flap plate 40), the bias voltage Vdc is also applied to the movable driving electrode 36 and the movable detection electrode 44.

The compensation signal generation circuit 140A generates a signal (the compensation signal Vcomp) with the same phase as the first driving signal V1 or the second driving signal V2 and applies the signal to the fixed detection electrode 46A. The compensation signal generation circuit 140A is configured to include a selection circuit 142 (an example of a selection unit) and a voltage adjustment circuit 144 (an example of a voltage adjustment unit).

The selection circuit 142 selects one of the first driving signal V1 and the second driving signal V2 input from the driving circuit 110.

As described above, in the vibration by the quadrature of the detection flap plate 40, there are two vibration patterns. Whether the compensation signal Vcomp has the same phase as the first driving signal V1 or the same phase as the second driving signal V2 is decided in accordance with the two vibration patterns.

For example, by inspecting which vibration pattern the vibration by the quadrature of the detection flap plate 40 is in advance, it is possible to determine whether the phase of the compensation signal Vcomp is the same as the phase of the first driving signal V1 or is the same as the phase of the second driving signal V2. Based on a result of the inspection, the selection circuit 142 is controlled to a state in which one of the first driving signal V1 and the second driving signal V2 input from the driving circuit 110 is selected.

The voltage adjustment circuit 144 adjusts the voltage of one of the first driving signal V1 and the second driving signal V2 input from the selection circuit 142 and generates a signal (the compensation signal Vcomp) with the same phase as the first driving signal V1 or the second driving signal V2. Hereinafter, a case in which the first driving signal V1 is selected by the selection circuit 142 will be described.

For example, when the first driving signal V1 is selected by the selection circuit 142, the voltage adjustment circuit 144 adjusts the voltage (amplitude) of the first driving signal V1 and generates the compensation signal Vcomp. For example, the voltage adjustment circuit 144 attenuates the first driving signal V1 at a predetermined attenuation ratio and generates the compensation signal Vcomp. The magnitude (voltage amplitude) of the compensation signal Vcomp can be appropriately set in accordance with desired performance of the gyro sensor 100. The magnitude (voltage amplitude) of the compensation signal Vcomp is set to a magnitude by which the amplitude of vibration by the quadrature of the detection flap plate 40 is equal to or less than a predetermined amplitude (preferably, the amplitude is zero).

The voltage adjustment circuit 144 applies the compensation voltage Vcomp to the fixed detection electrode 46A using the ground voltage Vgnd as a reference.

The compensation signal generation circuit 140B generates the signal (the compensation signal Vcomp) with the same phase as the first driving signal V1 or the second driving signal V2 and applies the signal to the fixed detection electrode 46B, as in the compensation signal generation circuit 140A. The compensation signal generation circuit 140B is configured to include a selection circuit 142 and a voltage adjustment circuit 144. The configuration of the compensation signal generation circuit 140B is the same as the configuration of the above-described compensation signal generation circuit 140A, and the description thereof will be omitted.

Here, when the compensation signal Vcomp is not given to the fixed detection electrodes 46A and 46B, the detection flap plate 40 vibrates by the quadrature (see FIG. 4). The amplitude of the vibration by the quadrature is considerably greater than the amplitude of the vibration of a Coriolis force (for example, thousands to tens of thousands times at 1 dps (degree/sec)). Therefore, the quadrature signal included in the detection signal may increase, and a signal may be saturated by the amplification circuit 122 at the initial stage of the detection circuit 120 in some cases.

However, when the compensation signal Vcomp is given to the fixed detection electrodes 46A and 46B, it is possible to suppress the vibration by the quadrature of the detection flap plate 40. Therefore, it is possible to reduce the quadrature signal included in the detection signal (or it is possible to remove the quadrature signal) and it is possible to cause a signal to be rarely saturated in the amplification circuit 122.

When the compensation signal Vcomp is given to the fixed detection electrodes 46A and 46B, the detection signal includes a signal occurring because of giving the compensation signal Vcomp to the fixed detection electrodes 46A and 46B. However, the magnitude of the signal included in the detection signal and occurring because of giving the compensation signal Vcomp is considerably smaller than the quadrature signal included in the detection signal, for example, when the compensation signal Vcomp is not given. As described above, this is because it is possible to cause the magnitude (voltage amplitude) of the compensation signal Vcomp to be less by using the resonance phenomenon. Accordingly, even when the compensation signal Vcomp is given to the fixed detection electrodes 46A and 46B, the saturation of the signal of the amplification circuit 122 rarely occurs.

The gyro sensor 100 can have the following characteristics, for example.

In the gyro sensor 100, the compensation signal generation circuits 140A and 140B generate the compensation signal Vcomp with the same phase as the first driving signal V1 or the second driving signal V2 and apply the compensation signal Vcomp to the fixed detection electrodes 46A and 46B. Therefore, in the gyro sensor 100, it is possible to suppress the vibration by the quadrature of the detection flap plate 40. Accordingly, it is possible to reduce the influence of the quadrature. In the gyro sensor 100, it is possible to suppress the vibration by the quadrature without adding a member such as an electrode suppressing the vibration by the quadrature of the detection flap plate 40. Accordingly, in the gyro sensor 100, it is possible to reduce the influence of the quadrature with a simple configuration.

As described above, in the vibration by the quadrature of the detection flap plate 40, there are two vibration patterns. In the gyro sensor 100, the compensation signal generation circuits 140A and 140B each include the selection circuit 142 that selects one of the first driving signal V1 and the second driving signal V2 input from the driving circuit 110. Therefore, in the gyro sensor 100, the compensation signal generation circuits 140A and 140B can generate the compensation signal Vcomp in accordance with the pattern of the vibration by the quadrature of the detection flap plate 40. Accordingly, it is possible to reduce the influence of the quadrature in any vibration pattern of the vibration by the quadrature of the detection flap plate 40.

In the gyro sensor 100, the compensation signal generation circuits 140A and 140B each include the voltage adjustment circuit 144 that adjusts a voltage of one of the first driving signal V1 and the second driving signal V2 input from the selection circuit 142. Therefore, the compensation signal generation circuits 140A and 140B can generate the compensation signal Vcomp that has the same phase as the input first driving signal V1 or second driving signal V2 and a desired magnitude (voltage amplitude).

In the gyro sensor 100, the vibrator 34 vibrates in the X axis direction when the first driving signal V1 is applied to the fixed driving electrodes 38 and the second driving signal V2 is applied to the fixed driving electrodes 39, and the movable detection electrode 44 is connected to the vibrator 34 and is displaced in the Z axis direction in accordance with the angular velocity. Therefore, in the gyro sensor 100, the angular velocity ωy around the Y axis can be obtained from a current based on a change in the capacity between the movable detection electrode 44 and the fixed detection electrode 46.

In the gyro sensor 100, the two movable detection electrodes 44 are installed and the two fixed detection electrodes 46 are installed. Of the two fixed detection electrodes 46, the one fixed detection electrode 46A (an example of a first fixed detection portion) is disposed to face the movable detection electrode 44 of the first structure 112a which is one of the two movable detection electrodes 44. Of the two fixed detection electrodes 46, the other fixed detection electrode 46B (an example of a second fixed detection portion) is disposed to face the movable detection electrode 44 of the second structure 112b which is the other of the two movable detection electrodes 44. The movable detection electrode 44 of the first structure 112a and the movable detection electrode 44 of the second structure 112b vibrate at mutually opposite phases in accordance with the first driving signal V1 and the second driving signal V2. Therefore, in the gyro sensor 100, since the detection signal from the fixed detection electrode 46A and the detection signal from the fixed detection electrode 46B can be differentially amplified, it is possible to detect the Coriolis signal with high precision.

In the gyro sensor 100, two compensation signal generation circuits (the compensation signal generation circuits 140A and 140B) are installed. The compensation signal generation circuit 140A (one of the two compensation signal generation circuits 140A and 140B) generates the compensation signal Vcomp and applies the compensation signal Vcomp to the fixed detection electrode 46A. The compensation signal generation circuit 140B (the other of the two compensation signal generation circuits 140A and 140B) generates the compensation signal Vcomp and applies the compensation signal Vcomp to the fixed detection electrode 46B. Therefore, even when the two detection flap plates 40 (the movable detection electrodes 44) are included in the gyro sensor 100, it is possible to reduce the influence of the quadrature with a simple configuration.

The example in which the first driving signal V1 and the second driving signal V2 are sine waves with mutually opposite phases has been described above, but the first driving signal V1 and the second driving signal V2 may be rectangular waves with mutually opposite phases. In this case, the compensation signal Vcomp may be a sine wave or a rectangular wave.

The example in which the sensor device 1 is the gyro sensor measuring the angular velocity ωy around the Y axis has been described above, but the sensor device 1 may be a sensor device that detects an angular velocity around the Z axis. In the sensor device 1 measuring the angular velocity around the Z axis, when an angular velocity ωz around the Z axis is applied to the sensor device 1 in a state in which the vibrators 34 vibrate in the X axis direction, the movable detection electrodes are displaced in the Y axis direction. By applying the compensation signal Vcomp with the same phase as the driving signal to the fixed detection electrodes facing the movable detection electrodes in the gyro sensor 100 including the sensor device 1, it is possible to reduce the influence of the quadrature.

### 1.5 Modification Example of Gyro Sensors

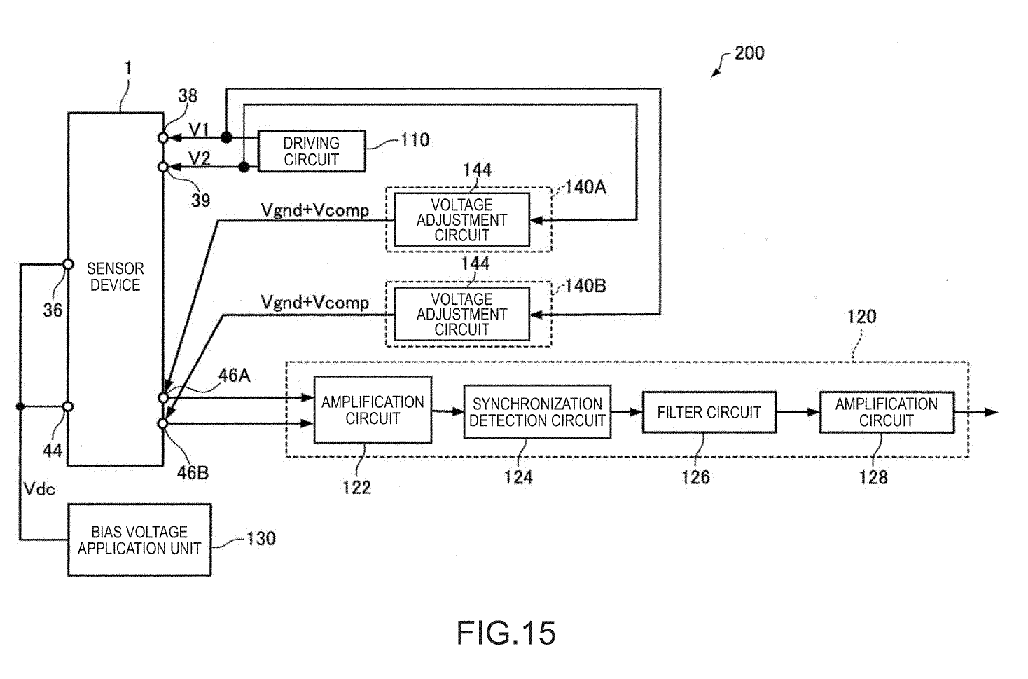

Next, a gyro sensor according to a modification example of the embodiment will be described with reference to the drawing. FIG. 15 is a functional block diagram illustrating a gyro sensor 200 according to a modification example of the embodiment. Hereinafter, in the gyro sensor 200 according to the embodiment, the same reference numerals are given to members that have the same functions as the constituent members of the gyro sensor 100 described above, the detailed description thereof will be omitted.

In the above-described gyro sensor 100, as illustrated in FIG. 14, the compensation signal generation circuits 140A and 140B are configured to include the selection circuit 142. In the gyro sensor 200, however, as illustrated in FIG. 15, the compensation signal generation circuits 140A and 140B do not include the selection circuit 142.

In the modification example, as the sensor device 1, a sensor device in which vibration by the quadrature of the detection flap plate 40 of the first structure 112a and the second structure 112b is the first vibration pattern is prepared in advance. Therefore, the second driving signal V2 is input from the driving circuit 110 to the compensation signal generation circuit 140A and the first driving signal V1 is input from the driving circuit 110 to the compensation signal generation circuit 140B.

The compensation signal generation circuit 140A adjusts the voltage of the second driving signal V2 input by the voltage adjustment circuit 144 and generates the compensation signal Vcomp with the same phase as the second driving signal V2. The compensation signal generation circuit 140A applies the generated compensation signal Vcomp to the fixed detection electrode 46A. Similarly, the compensation signal generation circuit 140B adjusts the voltage of the first driving signal V1 input by the voltage adjustment circuit 144 and generates the compensation signal Vcomp with the same phase as the first driving signal V1. The compensation signal generation circuit 140B applies the generated compensation signal Vcomp to the fixed detection electrode 46B.

As the sensor device 1, a sensor device in which vibration by the quadrature of the detection flap plate 40 of the first structure 112a and the second structure 112b is the second vibration pattern is prepared in advance. In this case, although not illustrated, the first driving signal V1 is input to the compensation signal generation circuit 140A and the second driving signal V2 is input to the compensation signal generation circuit 140B.

As the sensor device 1, a sensor device in which vibration by the quadrature of the detection flap plate 40 of the first structure 112a is the first vibration pattern and vibration by the quadrature of the detection flap plate 40 of the second structure 112b is the second vibration pattern may be prepared. As the sensor device 1, a sensor device in which vibration by the quadrature of the detection flap plate 40 of the first structure 112a is the second vibration pattern and vibration by the quadrature of the detection flap plate 40 of the second structure 112b is the first vibration pattern may be prepared. Even in this case, the driving signals V1 and V2 in accordance with the vibration patterns are input to the compensation signal generation circuits 140A and 140B.

In the gyro sensor 200 according to the modification example, the compensation signal generation circuits 140A and 140B do not include the selection circuit 142. Therefore, it is possible to reduce the influence of the quadrature with a simpler configuration.

### 2. Electronic Apparatus

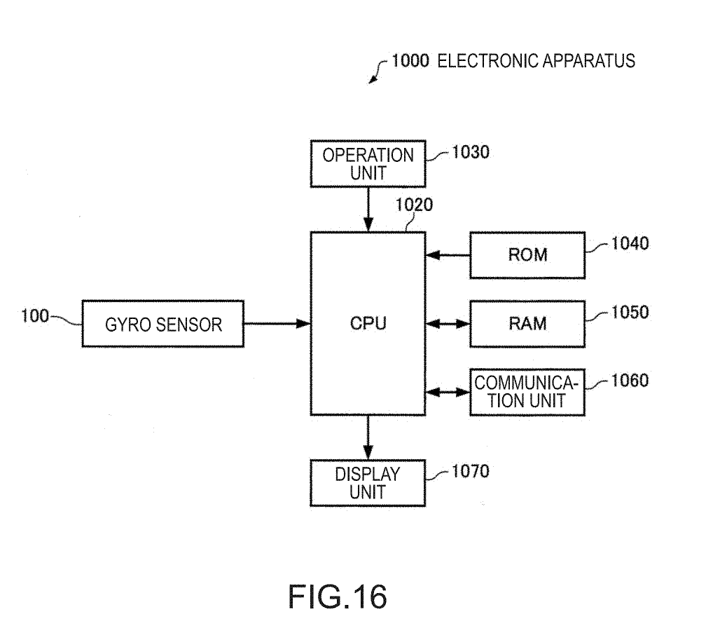

Next, an electronic apparatus according to an embodiment will be described with reference to the drawing. FIG. 16 is a functional block diagram illustrating an electronic apparatus 1000 according to an embodiment.

The electronic apparatus 1000 includes a gyro sensor according to the invention. Hereinafter, a case in which the gyro sensor 100 is included as the gyro sensor according to the invention will be described.

The electronic apparatus 1000 includes an arithmetic processing device (CPU) 1020, an operation unit 1030, a read-only memory (ROM) 1040, a random access memory (RAM) 1050, a communication unit 1060, and a display unit 1070. The electronic apparatus according to the embodiment may be configured such that some of the constituent elements (units) in FIG. 16 are omitted or modified or other constituent elements are added.

The arithmetic processing device 1020 performs various calculation processes or control processes in accordance with a program stored in the ROM 1040 or the like. Specifically, the arithmetic processing device 1020 performs, for example, various processes in accordance with an output signal of the gyro sensor 100 or an operation signal from the operation unit 1030, a process of controlling the communication unit 1060 to perform data communication with an external apparatus, and a process of transmitting a display signal to the display unit 1070 in order to display various kinds of information.

The operation unit 1030 is an input device configured to include an operation key or a button switch and outputs an operation signal appropriate to an operation by a user to the arithmetic processing device 1020.

The ROM 1040 stores, for example, data or programs used for the arithmetic processing device 1020 to perform various calculation processes or control processes.

The RAM 1050 is used as a working area of the arithmetic processing device 1020 and temporarily stores, for example, data or a program read from the ROM 1040, data input from the gyro sensor 100, data input from the operation unit 1030, and a calculation result obtained by the arithmetic processing device 1020 in accordance with various programs.

The communication unit 1060 performs various kinds of control to establish data communication between the arithmetic processing device 1020 and an external apparatus.

The display unit 1070 is a display device configured with a liquid crystal display (LCD) and displays various kinds of information based on display signals input from the arithmetic processing device 1020. A touch panel functioning as the operation unit 1030 may be installed in the display unit 1070.

Various electronic apparatuses are considered as the electronic apparatus 1000. Examples of the electronic apparatus include a personal computer (for example, a mobile personal computer, a laptop personal computer, or a tablet personal computer), a mobile terminal such as a smartphone or a portable telephone, a digital still camera, an ink jet ejecting apparatus (for example, an ink jet printer), a storage area network apparatus such as a router or a switch, a local area network apparatus, a mobile terminal base station apparatus, a television, a video camera, a video recorder, a car navigation apparatus, a real-time clock apparatus, a pager, an electronic organizer (also including a communication function unit), an electronic dictionary, a calculator, an electronic game apparatus, a game controller, a word processor, a workstation, a television telephone, a security television monitor, electronic binoculars, a POS terminal, a medical apparatus (for example, an electronic thermometer, a blood-pressure meter, a blood-sugar meter, an electrocardiographic apparatus, an ultrasonic diagnostic apparatus, or an electronic endoscope), a fish finder, various measurement apparatuses, meters (for example, meters for cars, airplanes, and ships), a flight simulator, a head-mounted display, a motion trace, a motion tracking, a motion controller, and a pedestrian dead-reckoning (PDR).

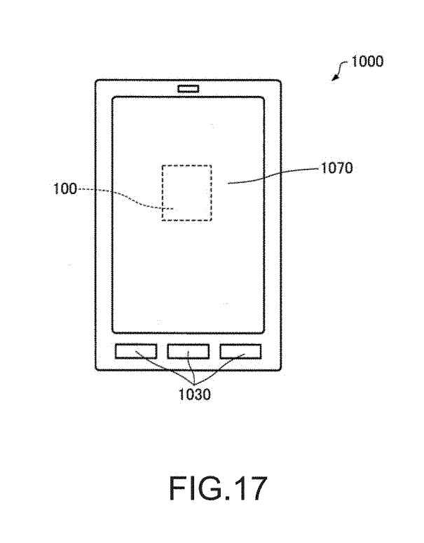

FIG. 17 is a diagram illustrating an exterior example of a smartphone which is an example of the electronic apparatus 1000. The smartphone which is the electronic apparatus 1000 includes buttons as the operation unit 1030 and an LCD as the display unit 1070.

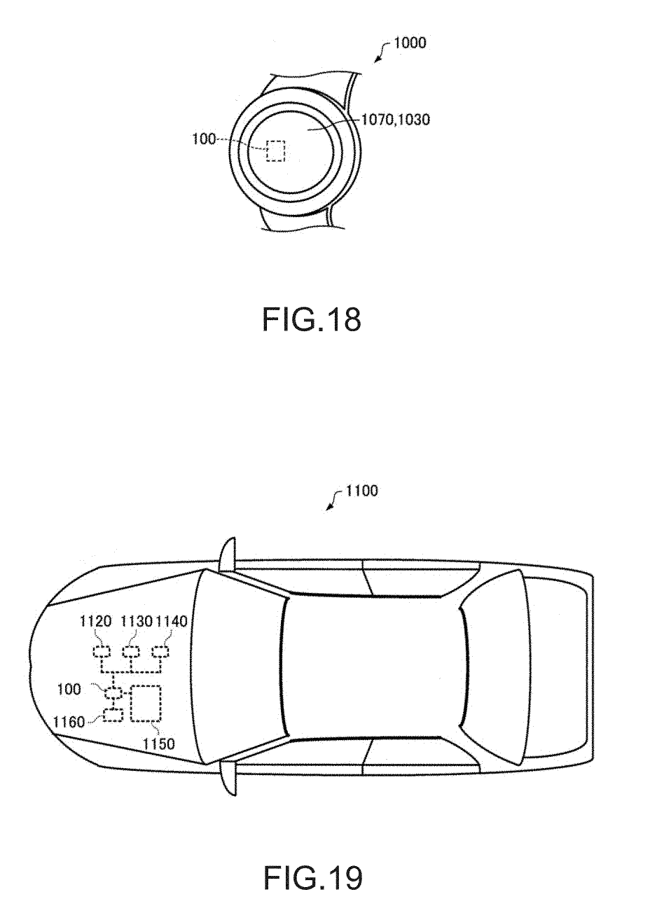

FIG. 18 is diagram illustrating an exterior example of an arm wearing type portable apparatus (wearable apparatus) which is an example of the electronic apparatus 1000. The wearable apparatus which is the electronic apparatus 1000 includes an LCD as the display unit 1070. A touch panel functioning as the operation unit 1030 may be installed in the display unit 1070.

The portable apparatus which is the electronic apparatus 1000 includes a positional sensor such as a Global Positioning System (GPS) receiver and can measure a movement distance or a movement trajectory of a user.

### 3. Vehicle

Next, a vehicle according to the embodiment will be described with reference to the drawing. FIG. 19 is a top view schematically illustrating an automobile which is an example of a vehicle 1100 according to the embodiment.

The vehicle according to the embodiment includes a gyro sensor according to the invention. Hereinafter, a vehicle that includes the gyro sensor 100 as the gyro sensor according to the invention will be described.

The vehicle 1100 according to the embodiment is configured to include a controller 1120, a controller 1130, a controller 1140, a battery 1150, and a backup battery 1160 controlling various kinds of control, such as an engine system, a brake system, and a remote handset system. The vehicle 1100 according to the embodiment may be configured such that some of the constituent elements (units) in FIG. 12 are omitted or modified or other constituent elements are added.

Various vehicles are considered as the vehicle 1100. Examples of the vehicle include an automobile (also including an electric automobile), an airplane such as a jet airplane or a helicopter, a ship, a rocket, and an artificial satellite.

The invention is not limited to the above-described embodiments and can be modified in various forms within the scope of the gist of the invention.

For example, in the embodiment, the detection flap plate is cantilever-supported by the beam portions 42. Further, for example, the detection flap plate 40 may be supported with elastic portions at four locations on the vibrator 34 and a main surface of the detection flap plate 40 can be displaced in the Z axis direction in a state in which the main surface is along the X-Y plane.

The invention includes substantially the same configurations (for example, configurations of the same functions, methods, and results or configurations of the same objectives and advantages) as the configuration described in the embodiments. The invention also includes configurations with which unsubstantial portions of the configurations described in the embodiments are substituted. The invention also includes configurations with which the same operational effects as those of the configurations described in the embodiments can be obtained or the same objectives can be achieved. The invention also includes configurations in which known technologies are added to the configurations described in the embodiments.

The entire disclosure of Japanese Patent Application No. 2017-021210 filed on Feb. 8, 2017 is expressly incorporated by reference herein.

What is claimed is:

1. A gyro sensor comprising:
a first signal generation unit that generates a first driving signal and a second driving signal with a different phase by 180 degrees from the first driving signal;
a movable detection portion that vibrates in accordance with the first and second driving signals and is displaced in accordance with an angular velocity;
a fixed detection portion that is disposed to face the movable detection portion; and
a second signal generation unit that generates a signal with the same phase as the first or second driving signal and applies the signal to the fixed detection portion.

2. The gyro sensor according to claim 1,
wherein the second signal generation unit includes a selection unit that selects one of the first and second driving signals input from the first signal generation unit.

3. The gyro sensor according to claim 1,
wherein the second signal generation unit includes a voltage adjustment unit that adjusts a voltage of one of the first and second driving signals.

4. The gyro sensor according to claim 1, further comprising:
a substrate;
first and second fixed driving electrodes that are fixed to the substrate;
a movable driving electrode that is disposed between the first and second fixed driving electrodes; and
a vibrator to which the movable driving electrode is connected,
wherein the vibrator vibrates when the first driving signal is applied to the first fixed driving electrode and the second driving signal is applied to the second fixed driving electrode, and
wherein the movable detection portion is connected to the vibrator.

5. The gyro sensor according to claim 1,
wherein two movable detection portions are installed,
wherein two fixed detection portions are installed,
wherein a first fixed detection portion which is one of the two fixed detection portions is disposed to face a first movable detection portion which is one of the two movable detection portions,
wherein a second fixed detection portion which is the other of the two fixed detection portions is disposed to face a second movable detection portion which is the other of the two movable detection portions, and
wherein the first and second movable detection portions vibrate in mutually opposite phases in accordance with the first and second driving signals.

6. The gyro sensor according to claim 5,
wherein two second signal generation units are installed,
wherein one of the two second signal generation units generates a signal with the same phase as the first or second driving signal and applies the signal to the first fixed detection portion, and
wherein the other of the two second signal generation units generates a signal with the same phase as the first or second driving signal and applies the signal to the second fixed detection portion.

7. An electronic apparatus comprising:
the gyro sensor according to claim 1;
an arithmetic processing device that performs an arithmetic process based on a signal output from the gyro sensor; and
a display unit that displays information under control of the arithmetic processing device.

8. An electronic apparatus comprising:
the gyro sensor according to claim 2;
an arithmetic processing device that performs an arithmetic process based on a signal output from the gyro sensor; and
a display unit that displays information under control of the arithmetic processing device.

9. A portable electronic apparatus comprising:
the gyro sensor according to claim 1;
an arithmetic processing device that performs an arithmetic process based on a signal output from the gyro sensor;
a communication unit that performs data communication with outside;
an operation unit that transmits an operation signal to the arithmetic processing device; and
a display unit that displays information under control of the arithmetic processing device.

10. A portable electronic apparatus comprising:
the gyro sensor according to claim 2;
an arithmetic processing device that performs an arithmetic process based on a signal output from the gyro sensor;
a communication unit that performs data communication with outside;
an operation unit that transmits an operation signal to the arithmetic processing device; and
a display unit that displays information under control of the arithmetic processing device.

11. The portable electronic apparatus according to claim 9, further comprising:
a GPS receiver,
wherein a movement distance or a movement trajectory of a user is measured.

12. The portable electronic apparatus according to claim 10, further comprising:
a GPS receiver,
wherein a movement distance or a movement trajectory of a user is measured.

13. A vehicle comprising:
the gyro sensor according to claim 1;
a system which is at least one of an engine system, a brake system, and a remote handset system; and
a controller that controls the system based on a signal output from the gyro sensor.

14. A vehicle comprising:
the gyro sensor according to claim 2;
a system which is at least one of an engine system, a brake system, and a remote handset system; and
a controller that controls the system based on a signal output from the gyro sensor.
